(19) United States
(12) Patent Application Publication
(10) Pub. No.: US 2006/0265429 A1
(43) Pub. Date: Nov. 23, 2006

(54) Systems, methods, and computer program products for optimizing communications with selected product providers and users by identifying trends in transactions between product providers and users

(75) Inventors: Richard Pendergast, Gainesville, TX (US); Kevin Slean, Loxahatchee, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP

(21) Appl. No.: 11/130,521

(22) Filed: May 17, 2005

(51) Int. Cl. G06F 17/30

(52) U.S. Cl. 707/201

(57) ABSTRACT

A system, method, and computer program product are provided for automatically identifying trends in the number of transactions occuring between selected users and selected product providers in order to determine which product providers and/or users are most productive or least productive over the course of a selected number of time periods such that marketing or communications may be focused on selected product providers and/or users exhibiting the most extreme upward or downward transactional trends. The system of the present invention determines and stores the number of transactions that occur between users (such as individual customers and/or affiliates) and a product provider (such as a hotel) over the course of a selected number of time periods and compares the stored transactional data to the number of transactions determined over the course of a recent number of selected time periods in order to determine a transactional trend.

### BACKGROUND OF THE INVENTION

1. Field of the Invention

The present invention relates to the field of computerized inventory systems, such as hotel reservations systems or other product and/or service reservation or inventory systems, which are used to determine and relay data related to products and/or services from selected product providers to customers. More particularly, the present invention relates to identification of trends in transactional activity between selected users and selected transaction systems so as to prioritize communications between selected users and transaction systems so as to focus limited marketing and communication resources on users and transaction systems exhibiting a selected trend.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline tickets, hotel reservations, car rentals, event tickets, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, and AXESS.

Consumer interaction with such systems has become more complex in recent years, thus introducing a host of technical problems related to the tracking of trends in transactions occurring via search systems that may be in communication with one or more CRS entities, a plurality of users, and individual product providers. Users may now interrogate multiple CRS entities via websites hosted by search systems that are configured to search for low-cost product options on a variety of CRS systems. For example, there exists a search system configured to provide a plurality of low airline fare prices and different flight itinerary options from various CRS entities for a given departure and return date combination entered by a user, thereby allowing a user to view these different options and make a determination as to which fare and flight itinerary meets their goals. Such a system is described more fully in U.S. Provisional Patent Application Ser. No. 60/573,546, filed on May 21, 2004, entitled, Systems, Methods, And Computer Program Products For Searching And Displaying Low Cost Product Availability Information For A Given Departure-Return Date Combination Or Range Of Departure-Return Date Combinations; the contents of which are incorporated herein. Such systems may also allow the user to search alternate computerized reservation systems hosted by individual hotels, hotel chains, airlines, or other product providers such that the user may initiate a variety of different transactions with one or more product providers via the search system.

In addition, third-party affiliates, such as “hotel guide” websites, now commonly offer search capabilities to individual customers for affordable hotel accommodations or other products by serving as “users” of the search system. Such third-party affiliates typically receive customer search requests and other transactions and subsequently pass on such search requests (as a user) to a search system that may then fully interrogate one or more CRS entities in response to the search request. In some cases, the third-party affiliate may also purchase a product (via the search system) from a product provider listed in the CRS in response to a customer input. Since many conventional search systems do not market to hotels, hotel chains, small airlines, or other individual product providers, third party affiliates often provide critical marketing services to the operators of such search systems and may assist both individual customers and search systems in obtaining more competitive product prices from the product providers by assuring a steady flow of individual customers to purchase the offered products.

While conventional search systems may provide an individual customer (either directly or via a third party affiliate) with a multitude of different product options including, in some cases, the lowest possible price for a given product at the time of the search, conventional search systems do not automatically identify and report trends in transactional activity between users (including third party affiliates) and product providers (such as an individual hotel). This technical problem is especially apparent in conventional search systems that may at least partially rely on third party affiliates for marketing efforts aimed at both individual customers and product providers. For example, conventional search systems lack the capability of automatically tracking and reporting trends in transactional activity between users (including both individual customers and third party affiliates) and product providers (which may include, for example, hotel CRS entities, and hotel chain CRS entities). Thus, the operator of the search system may not be aware of a product provider or a third-party affiliate that is exhibiting a rapid increase or decrease in transactions that may be due to a number of situations that may require the attention of the operator of the search system. For example, a third party affiliate exhibiting a rapid rise in transactional activity in a relatively short period of time may be engaging in risky internet marketing tactics such as “keyword stuffing” that may result in the third party affiliate being dropped as an internet site searched by large internet search engines. In another example, a steady marked decrease in transactional activity by a selected third party affiliate may indicate that the entity may be taking its business to another competing search system. In these and other examples, conventional search systems are incapable of automatically tracking and reporting such transactional trends to the operator of the search system. Thus, the operator of conventional search systems would be incapable of addressing such issues with third party affiliates or providing incentives for other product providers that may be exhibiting gradual upward transactional trends that may indicate prudent and successful marketing strategies.

Therefore, there exists a need for an improved system to solve the technical problems outlined above that are associated with conventional search systems. More particularly, there exists a need for a system configured to be capable of monitoring a product database to identify trends in transactional activity between a plurality of product providers and users of the product database such that an operator of the system may more effectively identify users (such as third party affiliates) and/or product providers that are exhibiting a rapid rise or fall in transactional acitivity over a selected number of time periods. There also exists a need for such a system that automatically generates a list of third party affiliates and product providers exhibiting a selected upward or downward trend in the number of transactions occuring over the selected number of time periods by automatically comparing a number of transactions determined during a selected time period to an average number of transactions historically recorded during a comparable time period and averaged over a selected number of time periods.

### BRIEF SUMMARY OF THE INVENTION

The needs outlined above are met by the present invention which, in various embodiments, also provides a system that overcomes many of the technical problems discussed above, as well other technical problems, with regards to monitoring a product database to identify trends in transactional activity between a plurality of product providers and a plurality of users (including third party affiliates) over a selected number of time periods. More specifically, the system of the present invention comprises, in one embodiment, at least one transaction system capable of performing transactions and a tracking system in communication with the transaction system. Furthermore, the tracking system tracks the number of transactions made by the transaction system for different time periods, determines an average number of transactions for the transaction system based on the transactions over different time periods, and compares the average number of transactions to the number of transactions for a selected time period to identify a trend in the number of transactions for the selected time period. For example, according to one embodiment, the tracking system determines the avearage number of transactions for an N number of time periods and the number of transactions for an N+1 time period and compares the average number of transaction for the N number of time periods to the number of transactions for the N+1 time period.

According to other system embodiments of the present invention the tracking system compares the transactions for successive time periods to the average number of transactions, wherein the comparisons define a slope. In other system embodiments, the tracking system applies a scaling factor to the determined slope wherein the scaling factor has a value that is dependent on the duration of the time periods. In other system embodiments, the tracking system determines a trend value representing the number of transactions for a selected time period for a plurality of transaction systems, and identifies at least one of transaction systems having upward trends and transaction systems having downward trends. Furthermore, the tracking system may identify transaction systems exhibiting identified upward or downward trends that exceed a threshold value.

The present invention also includes methods and computer program product embodiments for identifying trends in transactional activity of one or more transaction systems. The methods and computer program products comprise the steps of: providing at least one transaction system capable of performing transactions; tracking the number of transactions made by the transaction system for different time periods; determining an average number of transactions for the transaction system based on the transactions over different time periods; and comparing the average number of transactions to the number of transactions for a selected time period to identify a trend in the number of transactions for the selected time period. In some method and computer program product embodiments, the determining step further comprises determining the avearage number of transactions for an N number of time periods and the number of transactions for an N+1 time period. Furthermore, the comparing step further comprises comparing the average number of transaction for the N number of time periods to the number of transactions for the N+1 time period.

According to other method and computer program product embodiments, the method may further comprise comparing the transactions for successive time periods to the average number of transactions, wherein the comparisons define a slope. In some method embodiments, the method may further comprise applying a scaling factor to the determined slope wherein the applied scaling factor may be assigned a value that is dependent on the duration of the time periods (so as to allow for the emphasis of slopes computed using time periods of a selected duration). Furthermore, in some embodiments, the comparing step further comprises comparing the trend value for each transaction system to a first threshold value and identifying transaction systems having an associated trend value at least as great as the first threshold. Furthermore, the comparing step may also comprise comparing the trend value for each transaction system to a second threshold value, and identifying transaction systems having an associated trend value less that the second threshold.

Thus the systems, methods, and computer program products for identifying trends in transactional activity of one or more transaction systems provide a number of advanatages and solutions to the technical problems inherent in conventional search systems. Such advantages include, but are not limited to: providing a transactional tracking system such that an operator of a search system may be kept informed of transactional trends involving transaction systems, users (including, for example, third party affiliates), and product providers that utilize the transaction system or systems for hosting transactions, alerting an operator of the search system of transactional trends that may warrant attention to correct and/or incentivize certain business practices by transaction systems, users and/or product providers, identifying “rising stars” and/or “falling stars” within the ranks of third party affiliates that may substantially affect the business success of a particular search system, and allowing operators of the search system to fine tune the trend identification capabilities of the search system such that both long-term and short-term transactional trends may be accurately identified and tracked.

These advantages and others that will be evident to those skilled in the art are provided in the system, method, and computer program product of the present invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a system, according to one embodiment of the present invention, for monitoring a product database to identify trends in transactional activity between a plurality of product providers and a plurality of users.

FIG. 2 is a flow diagram illustrating a method, according to one embodiment of the present invention, for monitoring a product database to identify trends in transactional activity between a plurality of product providers and a plurality of users.

FIG. 3 is a flow diagram illustrating a method according to one embodiment of the present invention including a step for receiving payment from a user for a product purchased from a product provider.

FIG. 4 is a flow diagram illustrating a method according to one embodiment of the present invention including steps for determining a slope of a transactional trend, applying a scaling factor to the slope, and determining a difference between a determined and an average number of transactions between users and product providers.

FIG. 5 is a flow diagram illustrating a method according to one embodiment of the present invention including a step for generating a listing of users or product providers exhibiting a transactional trend that exceeds a selected trend value.

FIG. 6 is a flow diagram illustrating a method according to one embodiment of the present invention including a step for generating a listing of users or product providers exhibiting a difference between a determined and an average number of transactions between users and product providers that exceeds a selected difference.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. While the systems, methods, and computer program products of the present invention are described in a hotel reservation environment, it should be understood that this is only one non-limiting example of the possible use of the embodiments of the present invention. More specifically, the system, method, and computer program product embodiments of the present invention may be adapted to any number of products and services and are not limited to the monitoring of transactional trends between users (including both individual users and third-party affiliates) and a product source system offering low-price hotel accommodations. For example, the present invention may be used to automatically monitor transactional trends between users and product providers providing various products that may include, but are not limited to, travel tickets, cruises, restaurants, car rentals, sports events, and leisure activities.

The descriptions below disclose use of present invention to analyze product provider systems, such as inventory systems. It is understood that the present invention can be used in any system that handles transactions. A product provider system is a type of transaction system. Thus, the present invention is not limited to product provider systems. It has applicability in all types of transaction systems.

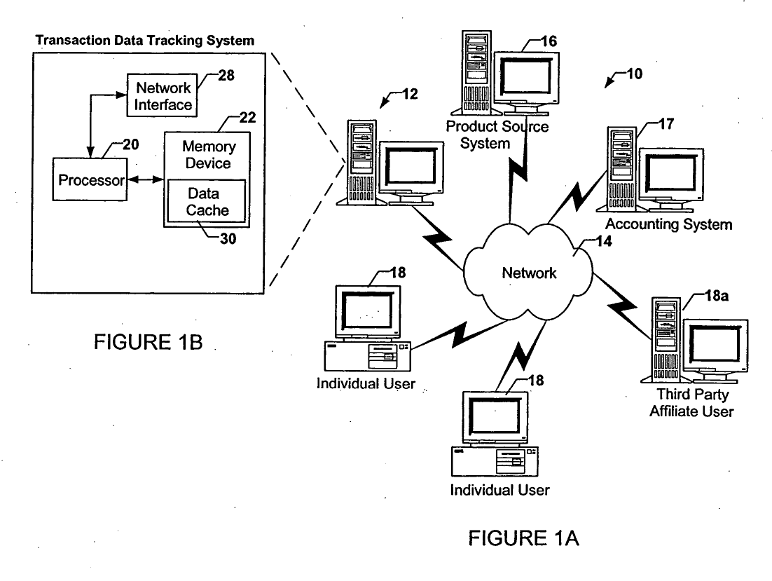

FIG. 1A shows a system 10, according to one embodiment of the present invention, for monitoring a product database to identify trends in transactional activity between a plurality of product providers (whose products may be listed in a product source system 16, such as a computer reservation system (CRS)) and one or more users 18, 18a (including both individual users 18 and third-party affiliates (18a). The system 10 comprises a product source system 16 (such as a hotel CRS) comprising product options information concerning one or more product options (such as hotel rooms) offered by one or more product providers (including, for example, individual hotels or hotel chains). As shown in FIG. 1A, different types of users 18, 18a may access the product source system 16 in order to select one or more products offered by the various product providers listed. For example, in some embodiments, individual users may access the product source system 16 via a user interface 18 in communication with the product source system via a computer network 14 (such as the internet). In other embodiments, individual users 18 may input a product query to a third-party affiliate 18a (which may operate a specialized website that focuses on searching for low-cost hotel accomodations). In turn, such third-party affiliates 18a may resubmit the query of the individual user 18 to the product source system 16 via the network 14.

Thus, individual users 18 may access the the various product options either directly via a product source system 16 (such as a computerized reservation system listing low-cost travel products offered by a variety of product providers via its own internet website) or via a third-party affiliate 18a operating its own internet website (such as a low-cost hotel booking service) that in turn brings individual user 18 queries to the usually larger and more comprehensive product source system 16 that may be operated by a travel company, hotel chain, airline, or other entity specializing in presenting a variety of product options provided by various product providers. According to various embodiments, and as shown generally in FIG. 1A, the individual users may be in communication with the product source providers 16 and third-party affiliates 18a via one or more user interfaces 18 that may be in communications with the product source providers 16 and third-party affiliates 18a via a network 14 (such as the internet). The user interfaces 18 may be capable of receiving input from the user to inititate a transaction related to a selected product option offered by a selected one of the plurality of product providers either directly via one or more of the product source systems 16 and/or indirectly via the third party affiliates 18a that also serve as third-party users of the product source system 16.

As shown in FIGS. 1A and 1B the system 10 of the present invention also comprises a transaction data tracking system 12 in communication with the product source system 16 and interfaces 18, 18a. As shown generally in FIG. 1B, the transaction data tracking system 12 comprises a memory device 22 for storing transaction information related to the transaction initiated by the user and a processor 20 (or processing element) in communication with the interfaces 18, 18a and the product source system 16 (or third-party affiliate 18a). The transactions tracked and/or stored by the transaction data tracking system 12 may include, but are not limited to, website “hits”, product option purchases, product option inquiries (such as a search for available rooms offered by a hotel chain), inquiries related to one of the plurality of product providers, and other transactions that may be initiated by the users of the system 10.

The processor 20 of the transaction data tracking system 12 may be configured to determine the product provider or user 18a associated with the transaction initiated, and to determine a number of transactions between at least one of the plurality of users and at least one of the plurality of product providers during a selected time period (such as a day, week, month, or travel season). For example, in cases where the user 18a is a third-party affiliate, the transaction data tracking system 12 may identify the specific third-party affiliate 18a that initiated the transaction so as to track the business traffic provided by various third-party affiliates 18a that may serve as users of the product source system. Thus, the transaction data tracking system 12 of the present invention may be capable of identifying particularly profitable third-party affiliates 18a and/or specific product providers whose products are listed via the product source system 16. The processor 20 may also be capable of storing transaction information, including the determined number of transactions between the at least one of the users 18, 18a and at least one of the plurality of product providers, in a first data set in the memory device 22.

According to some embodiments of the system 10, the processor 20 periodically computes an average number of transactions between at least one of the users 18, 18a and at least one of the plurality of product providers during a selected time period (such as an “average” week) by computing an average number of transactions per the selected time period over the course of a selected number of time periods. For example, the processor 20 may determine the number of transactions between the users 18, 18a and a particular hotel chain (or other product providers) per week over a selected number of weeks in order to determine the average number of transactions occurring between users 18, 18a and the particular product provider during an average one-week time period. In a similar manner, the processor 20 may determine the number of transactions between specific third-party affiliates 18a and the product source system 16 per week over a selected number of weeks in order to determine the average number of transactions initiated by a particular third-party affiliate 18a during a typical one-week time period do determine the average amount of transactional activity initiated by a particular third-party affiliate 18a during an average time period. In addition, the transaction data tracking system 12 may be further configured to store (via the memory device 22, for example) an average number of transactions per week received by a given product provider or initiated by a particular third party affiliate 18a during both peak season (such as during the summer months or other peak travel season) as well as the average number of transactions per week during an off-season interval. Furthermore, in order to identify trends in the number of transactions occuring between users and a selected product provider (such as a particular hotel or hotel chain), as well as trends in the number of transactions initiated by a particular third-party affiliate 18a, the processor 20 of the transaction data tracking system 12 periodically compares the average number of transactions per the selected time period to the determined number of transactions stored in the first data set within a data cache 30 of the memory device 22. Thus, the transaction data tracking system may be capable of identifying particular product providers (and third-party affiliates 16a) that are exhibiting significant increases or decreases in transactional activity over the course of a selected number of time periods.

Also, as shown generally in FIG. 1A, the system 10 may further comprise an accounting system 17 (in communication with the transaction data tracking system 12, product source system 16, and various other interfaces by which users 18, 18a may access the system 10). The accounting system 17 is capable of receiving payments from the plurality of users 18, 18a for product options selected for purchase wherein the transaction initiated by the users 18, 18a is a purchase. In cases wherein the transaction is a purchase (of a hotel room, for example) initiated by an individual user 18, the accounting system 17 may be conifgured to be capable of receiving a credit card payment or other payment type via a computer network 14. In other embodiments, wherein the transaction is a pass-through purchase between a third party affiliate 18a and a product source system 16 (or the system 10 of the present invention), the accounting system 17 may be capable of receiving a commission payment from the third-party affiliate 18a for the use of the system 10 of the present invention to satisfy an individual user's 18 product query received by the third-party affiliate 18a.

According to some embodiments the processor 20 of the transaction data tracking system 12 determines a slope of a component trend in the number of transactions occuring between users 18, 18a and at least one of the plurality of product providers during the selected time period. The component trend (F[X], shown, for example, as equation (2), below) may be defined as a component of the trend (FR[X], shown, for example, as equation (5) below) in the number of transactions occuring between users and a selected product provider (such as a particular hotel or hotel chain). The component trend (F[X]) may also be defined as a component of trends (FR[X], for example) in the number of transactions initiated by a particular third-party affiliate 18a. In other words, the component trend (F[X]) may be used in the determination of the trend (FR[X]) as indicated in equation (5) below. For example, the processor 20 may be capable of determining a slope that may be defined as a percentage increase (corresponding to a positive slope) or a percentage decrease (corresponding to a negative slope) in the determined number of transactions as compared to the determined number of transactions for the particular product provider during a corresponding time period ending some time before the selected time period. In addition, the processor 20 may also be capable of determining a percentage increase (corresponding to a positive slope) or a percentage decrease (corresponding to a negative slope) in the determined number of transactions during the selected time period as compared to the determined number of transactions initiated via a particular third-party affiliate 18a during the earlier corresponding time period. For example, the slope (S) of such a component trend may be defined as:
S=(N[0]+N[−1])/N[−1] (1)
Wherein N[0] is the number of transactions determined during the selected time period (such as the present week) and [N−1] is the number of transactions determined during the corresponding earlier time period (such as the week prior to the present week). Thus, the slope (S), may be defined in this example as the percentage increase (or decrease) in the number of transactions occurring between a particular user 18, 18a and a particular product provider over the course of two consecutive weeks.

Furthermore, according to some embodiments, the processor 20 of the transaction data tracking system 12 may be capable of determining a difference between the determined number of transactions and the average number of transactions over a selected number of time periods (such as a selected number of days, weeks, or months). The “selected time period” and/or the “selected number of time periods” may be adjusted by an operator of the system 10 of the present invention such that the slope may indicate a percentage increase or decrease and/or an overall increase or decrease (as compared to the average number of transactions determined by the transaction data tracking system 12) for a variety of different time periods, including daily, weekly, monthly, or any other selected time period.

In other embodiments of the system 10 of the present invention, the processor 20 of the transaction data tracking system 12 may be further configured to be capable of applying a scaling factor (K) to the determined slope (as defined above and shown, for example, as equation (1)), wherein the scaling factor has a greater absolute value corresponding to a greater selected number of time periods (such as 6 consecutive selected time periods) and a lesser absolute value corresponding to a lesser selected number of time periods (such as 2 consecutive selected time periods). According to other system embodiments, the transaction data tracking system 12 may be configured to be capable of receiving scaling factors (input by an operator of the system 10 of the present invention, for example) having a variety of different values that may be “tuned” to emphasize shorter term trends so as to be capable of detecting and highlighting a rapid short-term increase or decrease in transactional activity. Using such “tunable” scaling factors, an operator of the system 10 may, for example, be capable of using the transaction data tracking system 12 to identify short term trends exhibited by a third-party affiliate 18a (such as a rapid increase in transactional activity) that may indicate the affiliate's 18a use of questionable internet marketing techniques such as “keyowrd stuffing” that may result in long-term difficulties.

For example, a trend (F[X]) in the number of transactions determined between a user 18, 18a and a selected product provider may be determined by the processor 20 of the present invention wherein the processor computes a component trend (F[X]) as follows:

$$\begin{matrix}F [ X ] = K [ 0 ] * ( N [ 0 ] + N [ - 1 ] / N [ 1 ] + K [ 1 ] * ( ( N [ 0 ] + \\ N [ - 1 ] ) - ( N [ - 2 ] + N [ - 3 ] ) ) / ( N [ - 2 ] + N [ - 3 ] ) + \\ K [ 2 ] * ( ( N [ 0 ] + N [ - 1 ] + N [ - 2 ] ) - ( N [ - 3 ] + \\ N [ - 4 ] + N [ - 5 ] ) ) / ( N [ - 3 ] + N [ - 4 ] + N [ - 5 ] + \\ K [ 3 ] * ( ( N [ 0 ] + N [ - 1 ] + N [ - 2 ] + N [ - 3 ] ) - \\ ( N [ - 4 ] + N [ - 5 ] + N [ - 6 ] + N [ - 7 ] ) ) / \\ ( N [ - 4 ] + N [ - 5 ] + N [ - 6 ] + N [ - 7 ] )\end{matrix} \qquad ( 2 )$$

The component trend (F[X]) computed by the processor 20 in this example includes a sum of slopes determined over several selected number of time periods multiplied by appropriate scaling factors (K) having a value appropriate to the selected number of time periods. For example, K[0] shown in equation (2) is multiplied by the slope shown generally in equation (1) corresponding to the percentage increase or decrease in the determined number of transactions between a particular user 18, 18a and a particular product provider during during two consecutive weeks. In addition, the scaling factor K[1] (wherein K[1]>K[0]) is multiplied by the slope corresponding to the percentage increase or decrease in the determined number of transactions between a particular user 18, 18a and a particular product provider during during four consecutive weeks (represented by N[0] (determined number of transactions for the week currenrly ending), N[−1] (determined number of transactions for the last week), N[−2] (determined number of transactions for the week prior to last week), and N[−3]. Similarly, the scaling factor K[2] (wherein K[2]>K[1]>K[0]) is multiplied in equation (2) by the slope corresponding to the percentage increase or decrease in the determined number of transactions between a particular user 18, 18a and a particular product provider during during eight consecutive weeks. Thus, according to this particular embodiment of the system 10 of the present invention, the eight week slope is emphasized in the determination of the component trend (F[X]) by the processor 20 of the transaction data tracking system 12 using a scaling factor K[2] having an absolute value that is greater than the scaling factors (K[1] and K[0]) corresponding to the four week and two week slopes, respectively.

Thus, the transaction data tracking system 12 may be capable of deemphasizing short-term component trends that may provide false indications that a particular product provider or third-party affiliate 18a is exhibiting a large increase or decrease in transactional activity. The transaction data tracking system 12 may be capable of emphasizing longer-term trends that may be better indicative of the relative success or failure of a particular product provider and/or affiliate 18a in bringing individual users' 18 business to a particular product source system 16. For example, the processor 20 may, via the application of scaling factors (the “K” values in equation (2), for example) to the trend (F[X]) determination, be capable of discerning a sudden weekly drop in the number of transactions (that may be the result of a server problem or other short-term communication problem between individal users 18 and the product provider, affiliate 18a, or other product source system 16) from a month-long drop in the number of transactions that may indicate that a particular product provider is not providing acceptable levels of service or competitive prices. In addition, the system 10 of the present invention may be also capable of determining when third-party affiliates 18a exhibit a long-term drop in transaction activity that may indicate that the third-party affiliate 18a has moved to an alternate product source system 16 in order to satisfy the product queries of its individual users 18. Thus, the transaction data tracking system 12 of the system 10 of the present invention may allow the operator of a product source system 16 to better respond to product providers (or affiliates 18a) that are exhibiting long-term increases or decreases in transactional activity so as to be capable of either addressing problems or rewarding positive business practices that are manifested in long-term decreases or increases in transactional activity.

According to some additional embodiments, the transaction data tracking system 12 of the system 10 of the present invention may be further configured to be capable of deemphasizing low-frequency trends (such as seasonal trends in the number of transactions occuring between users 18, 18a and product providers). For example, according to some embodiments, the processor 20 of the transaction data tracking system 12 may be configured to be capable of utilizing the average number of transactions determined between at least one of the users 18, 18a and at least one of the plurality of product providers during a selected time period (such as an “average” week) to modify the trend (F[X]). For example, an average A[X] number of transactions occuring between a user 18, 18a and a particular product provider per week (the selected time period) over the course of a selected 8-week period (the selected number of time periods) may be computed as follows:
A[X]=(N[0]+N[−1]+N[−2]+N[−3]+N[−4]+N[−5]+N[−6]+N[−7])/8 (3)
Where N[X] is the determined number of transactions between a particular user 18, 18a (such as a particular third-party affiliate 18a) and a product provider during the indicated week (N[0] represents the number of transactions determined during the week currently ending and N[−7] represents the number of transactions during the week 7 weeks prior to the week currently ending).

Furthermore, the processor 20 of the transaction data tracking system 12 may be further configured, in some embodiments, to utilize the selected time period average A[X] computed according to equation (3) as well as the trend F[X] computed according to equation (2), in order to generate an average resultant computed factor FA[0], as follows:
FA[0]=Average of (F[X]*A[X])/Average of (A[X]) (4)
Where Average of (F[X]*A[X] may be defined as the average of the F[X]*A[X] taking into account each of the possible user 18, 18a and product provider combinations, and wherein Average of A[X] may be defined as the average A[X] taking into account each of the possible user 18, 18a and product provider combinations.

In addition, according to some system 10 embodiments, the processor 20 of the transaction data tracking system 12 may be further configured to be capable of removing low-frequency variability (such as seasonal transactional trends) from the determination of the overal trend (FR[X]) in the number of transactions occuring between the users 18, 18a and a product provider. For example, the processor 20 may be capable of utilizing the average resultant computed factor (FA[0]) and the component trend (F[X]) to determine the overall transactional trend FR[X] for a given user 18, 18a or product provider as follows:
FR[X]=F[X]−FA[0] (5)
Wherein F[X] is the component trend defined generally as the weighted sum of the slopes (see Equation (1)) in the transactions occuring between users and product providers over a selected number of time periods and wherein FA[0] is the resultant computed factor used to take account of seasonal or other low-frequency trends that may affect the transactional activity of all individual users 18, third-party affiliates 18a, and product providers listed in the product source system 16 of the system 10 of the present invention.

According to some alternate embodiments of the system 10 of the present invention, the processor 20 of the transaction data tracking system 12 may be further configured to be capable of generating a list of product providers exhibiting a trend (FR[X], for example) in the number of transactions occuring between users 18, 18a and at least one of the plurality of product providers during the selected time period that exceeds a selected trend value. For example, an operator of the system 10 may input a specific selected trend value (corresponding to a selected increase and/or decrease in transactional activity during a selected time period) that may be stored in the data cache 30 of the memory device 22 such that the processor 20 may generate a list of product providers exhibiting an upward or downward trend in transactional activity that exceeds the selected trend value (that may, for example, be directly comparable to the determined FR[X] (see Equation (5)). Thus, the system 10 of the present invention may be capable of identifying product providers listed via the product source system 16 that may have increasing and/or decreasing popularity with individual users 18 or third-party affiliates 18a that may issue queries and/or purchase orders for product options offered by the identifed product providers. Similarly, the processor 20 of the transactional data tracking system 12 may also be configured to be capable of generating a list of product providers exhibiting the determined difference between the determined number of transactions and the average number of transactions per the selected time period that exceeds a selected difference. Thus, an operator of the system 10 may alternatively choose to obtain a list of product providers (provided by the processor 20) that exhibit a difference in the overall number (instead of a percentage) of transactions when compared to the average number of transactions for the selected time period.

According to other embodiments of the system 10 of the present invention, the processor 20 of the transaction data tracking system 12 may be capable of generating a list of users 18, 18a (such as particular third-party affiliates 18a) exhibiting a determined trend of the number of transactions initiated by the users 18, 18a during the selected time period that exceeds a selected trend value that may be input by an operator of the system 10 and subsequently stored in the memory device 22 of the transaction data tracking system 12. Thus the system 10 of the present invention may also be configured to be capable of identifying users 18, 18a, and particularly, third-party affiliates 18a that are exhibiting an exceptional increase and/or decrease in transactional activity during a specified time period. In addition, the processor 20 of the transactional data tracking system 12 may also be configured to be capable of generating a list of users 18, 18a initiating a number of transactions that exceeds the average number of transactions per the selected time period by a selected difference. Thus, an operator of the system 10 may alternatively choose to obtain a list of users 18, 18a (such as third-party affiliates 18a) that exhibit a difference in the overall number (instead of a percentage) of transactions when compared to the average number of transactions for the selected time period.

In some system 10 embodiments, the processor 20 of the transaction data tracking system 12 may be capable of generating a list of users 18, 18a (such as particular third-party affiliates 18a) wherein the list includes (and may be ranked according to) trend values (such as FR[X], for example) determined by the processor 20 of the transaction data tracking system. According to such embodiments, the system 10 may generate listings of third party affiliates 18a that may include, but are not limited to: third party affiliate 18a identifying information (billing number or ID number, for example), third-party affiliate 18a name, SRC code (which may comprise the “source” code or other unique identifying information for a third party affiliate 18a), third party affiliate 18a website name and/or URL, average transactions initiated by the third-party affiliate 18a during the selected time period, determined trend (such as FR[X] value computer by the transaction data tracking system 12 for the listed third-party affiliate 18a), and the raw number corresponding to the overall increase or decrease in the number of transactions initiated by the listed third-party affiliate 18a.

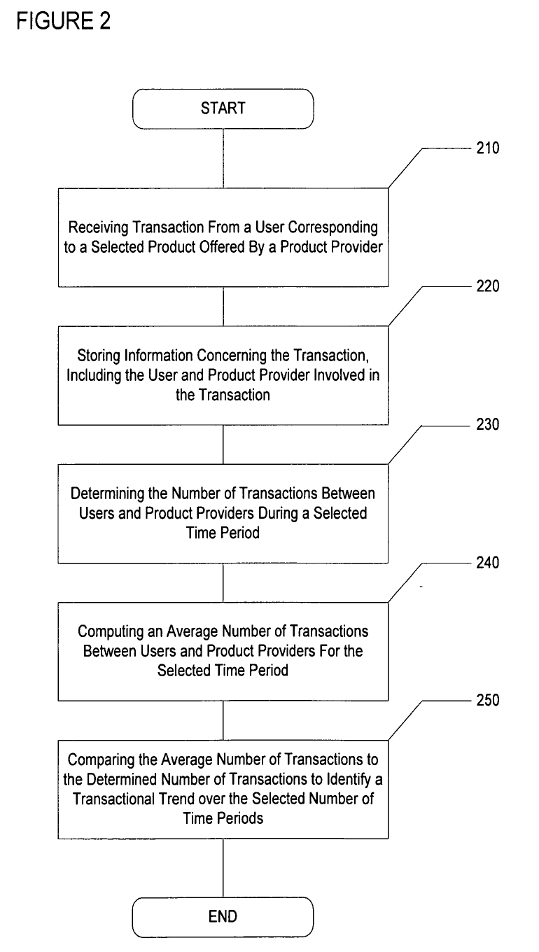

As shown generally in FIG. 2, the present invention also includes a method for monitoring a product database (including one or more product source systems 16) in order to identify trends in transactional acitvity between a plurality of product providers and a plurality of users 18, 18a (including, for example, third-party affiliates 18a and/or websites operated thereby) during a selected time period. Step 210 comprises receving from at least one of the plurality of users (including both individual users 18 and/or third party affiliates 18a) a transaction corresponding to a selected product offered by at least one of the plurality of product providers. The transaction received may be a variety of transaction types that may be initiated by an indivdual user 18 and/or a third-party affiliate user 18a including, but not limited to, the following: website hits; product purchases; product inquiries; or other transaction types.

As shown in FIG. 2, step 220 comprises storing information concerning the transaction, including the product provider offering the selected product and the user 18, 18a providing the transaction, in a storage device 22 (such as the memory device 22 of the transaction data tracking system 12 as described generally above). The method further comprises step 230, which includes determining the number of transactions between the at least one of the plurality of users 18, 18a and at least one of the plurality of product providers during a selected time period (such as a given day, week, month, or other selected time period). Furthermore, the method embodiment generally shown in FIG. 2 further comprises step 240, for computing an average number of transactions between the at least one of the plurality of users 18, 18a and at least one of the plurality of product providers for the selected time period by determining an average number of transactions per the selected time period over a selected number of time periods. For example, a processor 20 (included as part of a transaction data tracking system 12) may be configured to compute an average number of transactions intitated by a particular third-party affiliate 18a during a typical week by storing the number of transactions (in a memory device 22, for example) determined (as in step 230) during a plurality of one-week periods and computing an average number of transactions intitated by a particular third party affiliate during an “average” week (as shown generally above in equation (3), corresponding to the A[X] calculation). Then, as shown generally in step 250, the method embodiments of the present invention may further comprise comparing the “average” number of transactions per the selected time period (as computed in step 240, for example) to the determined number of transactions (as determined in step 230, for example) in order to identify a trend in the number of transactions occuring between the at least one of the plurality of users 18, 18a and at least one of the plurality of product providers (whose products are offered to the users 18, 18a via one or more product source systems 16) over the selected number of time periods. According to some method embodiments, step 250 may comprise utilizing the computed average number of transactions (A[X], as shown in equation (3), above) and the component trend (F[X], as shown, for example, in equation (1), above) to identify an overall trend in the number of transactions occuring between at least one of the plurality of users 18, 18a and at least one of the plurality of product providers over a selected number of time periods (such as an eight week period, as summarized above with respect to exemplary equations (1)-(5)).

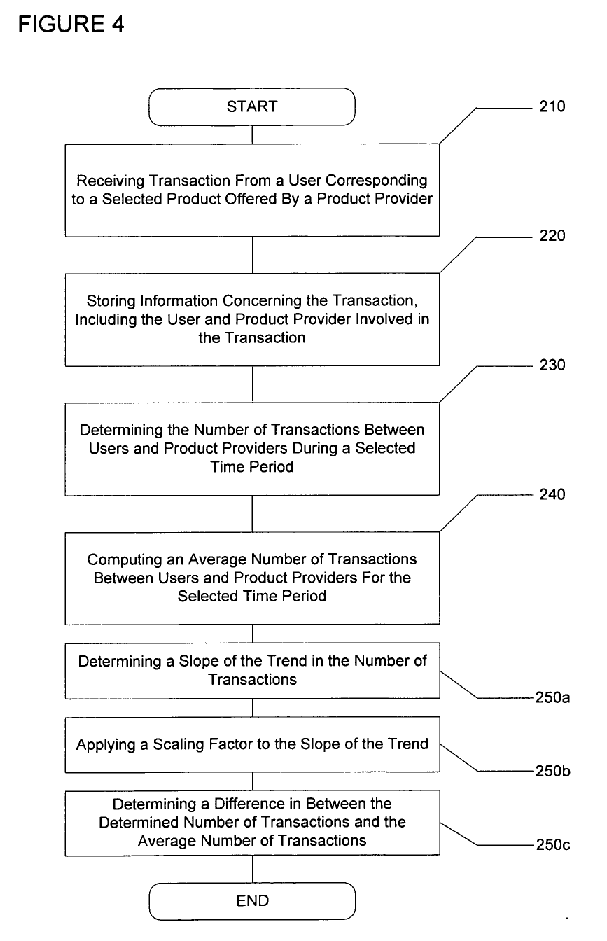

FIG. 4 generally illustrates an additional method embodiment of the present invention wherein the comparing step (step 250, as shown in FIG. 2) further comprises component steps 250a, 250b, and/or 250c. For example, the comparing step 250 may, in some method embodiments of the present invention, further comprise determining a slope (such as S, as shown generally in equation (1) above) of the trend in transactional activity occuring between users 18, 18a and product providers (via a product source system 16, for example) over a selected number of time periods (such the weekly increase or decrease in the number of transactions over the course of a consecutive two-week period as shown generally in equation (1) above).

Additionally, as shown in step 250b of FIG. 4, the comparing step 250 may further comprise applying a scaling factor (such as K[0] as shown in equation (2), for example) to the slope (S) determined in step 250a. As described generally above with respect to the system 10 and transaction data tracking system 12 descriptions, the scaling factors may be tailored to emphasize long-term slope determinations (such as an eight-week series of one-week periods) such that the scaling factor has a greater absolute value corresponding to a greater selected number of time periods and a lesser absolute value corresponding to a lesser selected number of time periods. Thus, for the computation of the component trend (F[X], as shown generally in equation (2) above) the scaling factor applied to the eight week slope (K[2], for example) may have a greater absolute value than the scaling factor applied to the four week slope (K[1]) such that the eight week slope (corresponding to a longer-term transactional trend) may be emphasized relative to shoter-term transactional trends. According to other method embodiments, the step 250b may comprise applying scaling factors (K) (wherein the scaling factors may be input by an operator of the system 10) having a variety of different values that may be selected or “tuned” by the operator to emphasize shorter term trends so as to be capable of detecting and highlighting a rapid short-term increase or decrease in transactional activity. Using such “tunable” scaling factors, an operator of the system 10 may, for example, be capable of using the transaction data tracking system 12 to identify short term trends exhibited by a third-party affiliate 18a (such as a rapid increase in transactional activity) that may indicate the affiliate's 18a use of questionable internet marketing techniques such as “keyword stuffing” that may later result in long-term declines in transactional activity.

In addition, and also as shown in FIG. 4, the comparing step 250 may further comprise step 250c including determinine a difference between the determined number of transactions and the average number of transactions over the selected number of time periods. Thus, as shown generally in eqautions (3)-(5) above, the average number of transactions for a given seasonal period may be utilized to eliminate low-frequency trends that may not be indicative of the relative success or failure of a particular third party affiliate 18a relative to peer users of the system 10 and may result instead from seasonal travel trends that affect all users. For example, the average number of transactions (A[X], for example) may be used along with the component trend F[X] to compute average resultant computed factor FA[0], as shown generally in equation (4). Step 250c may then comprise completing the comparison of the average resultant computed factor FA[0] with the component trend (F[X]) to determine the overall trend (FR[X]) as shown generally in equation (5) above.

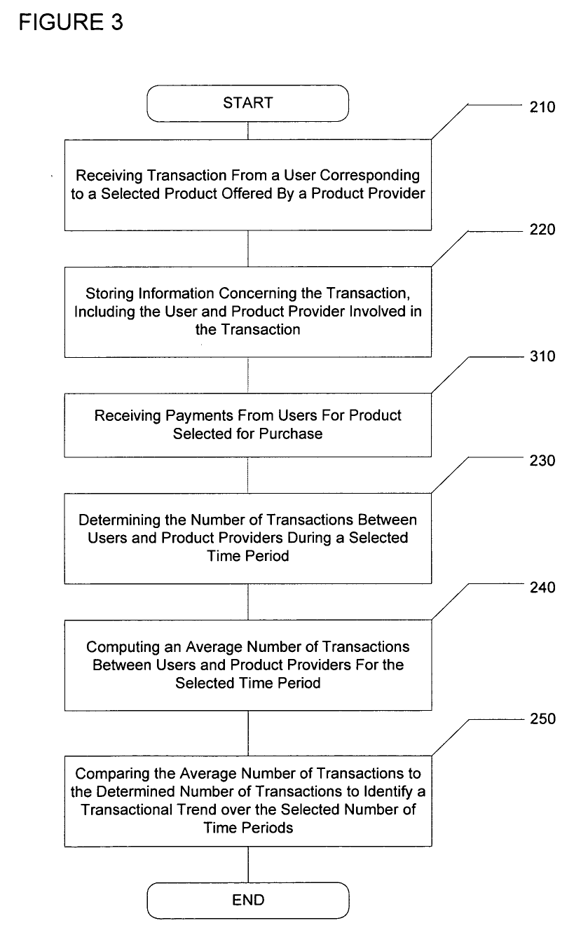

According to some method embodiments of the present invention, the method may further comprise (as shown generally in FIG. 3) step 310 for receiving payments from the plurality of users 18, 18a for product options selected for purchase wherein the transaction is a purchase. The receving payments step 310 may be performed by an accounting system 17 in communication with the system 10 embodiments of the present invention as described generally above. Furthermore, in examples where the transaction is a purchase (such booking a hotel room, for example) initiated by an individual user 18, step 310 may comprises receiving a credit card payment or other payment type via a computer network 14. In other embodiments, wherein the transaction is a pass-through purchase between a third party affiliate 18a and a product source system 16 (or the system 10 of the present invention), step 310 may comprise receiving a commission payment from the third-party affiliate 18a for the use of the system 10 of the present invention to satisfy an individual user's 18 product query received by the third-party affiliate 18a.

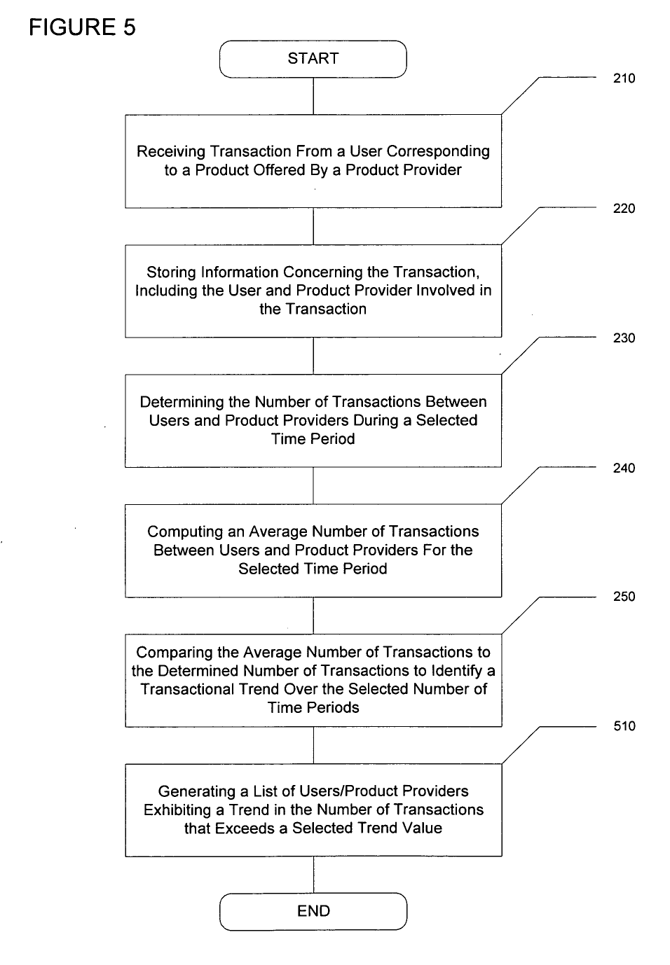

FIG. 5 shows an additional embodiment of the method of the present invention including step 510 which comprises generating a list of users 18, 18a and/or product providers exhibiting the trend (such as FR[X] (see equation (5), for example) in the number of transactions occuring between a user 18, 18a and a product provider over the selected number of time periods that exceeds a selected trend value. In the system 10 embodiments of the present invention, the memory device 22 of the transaction data tracking system 12 may be capable of receiving and storing a selected trend value that may be input by an operator of the system 10 of the present invention such that the method of the present invention may include step 510 for generating a list of third party affiliates 18a that are exhibiting an either upward or downward trend (such as a computed FR[X] trend value) that exceeds the selected trend value over the course of a selected number of time periods (such as an eight-week period as described above).

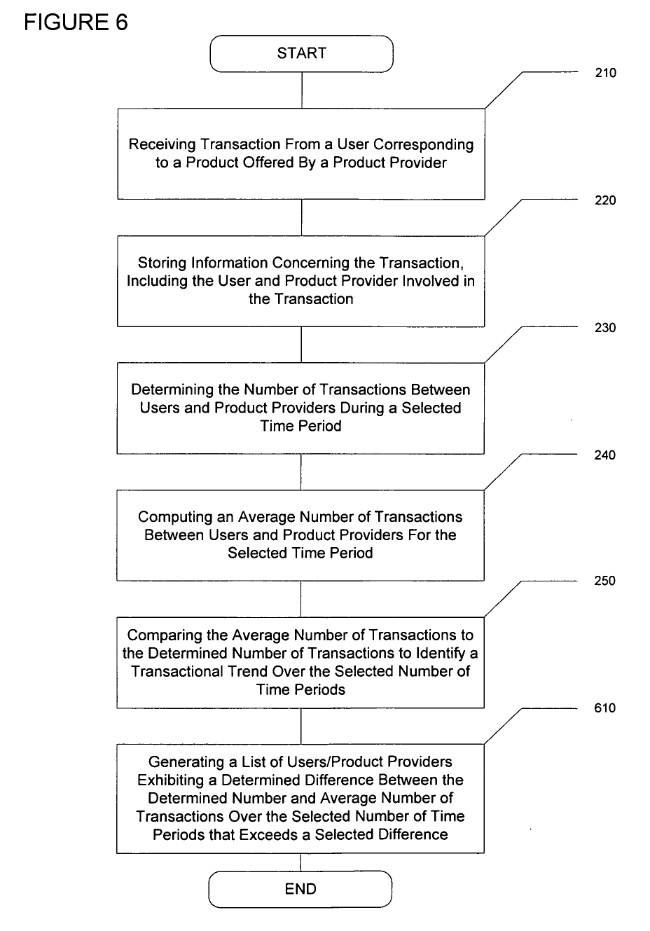

In addition, as shown in FIG. 6, the method embodiments of the present invention may further comprise step 610 for generating a list of users 18, 18a and/or product providers exhibiting a determined difference between the determined number of transactions and the average number of transactions (A[X], for example) that exceeds a selected difference during a selected time period or over the course of a selected number of time periods. As described above with respect to the selected trend value, the system 10 embodiments of the present invention may be configured such that the memory device 22 of the transaction data tracking system 12 may be configured to receive and store a selected difference in order to make the comparison and listing steps (as shown as steps 250 and 610 in FIG. 6) possible according to the method embodiments of the present invention.

Thus, one exemplary embodiment of the method of the present invention may comprise (as in step 510 of FIG. 5 and step 610 of FIG. 6) creating a report of “rising stars” and “falling stars” (corresponding to third party affiliates 18a that are either exceeding or falling behind the transactional activity of their peer users 18, 18a). In such an exemplary embodiment, a “rising star” may be defined generally as a third party affiliate 18a (such as a travel or hotel booking website) that is initiating transactions (such as bookings via the system 10 of the present invention) at a rate that is rising the fastest relative to their peer group of users (such as comparable third party affiliates 18a). Similarly, a “falling star” may be defined as a third party affiliate 18a that is initiating transactions (such as bookings via the system 10 of the present invention) at a rate that is rising the fastest relative to their peer group of users. According to one embodiment, such a report or listing may identify the following: the 10 long-term “falling stars” (including third party affiliates 18a initiating greater than 100 average transactions per week, that have dropped over the last 8 weeks), the 10 long-term large “rising stars” (including third party affiliates 18a initiating greater than 100 average transactions per week, that have increased over the last 8 weeks), the 10 long-term small “rising stars” (including third party affiliates 18a initiating greater than 10 average bookings and less than 100 per week, that have increased over the last 8 weeks, and, the overall long-term rise or fall of the entire group of third-party affiliates 18a during the last week (relative to the prior week's determined number of transactions).

In addition, the report or listing generated according to step 510 of the method embodiment described above may comprise data elements that may include (but are not limited to): third party affiliate 18a identification number, third party affiliate 18a name, SRC code (which may comprise the “source” code or other unique identifying information for a third party affiliate 18a); third party affiliate 18a website name or URL; average transactions initiated by the third party affiliate for the selected time period (such as a one-week period); the computed trend (FR[X], for example); and the raw number corresponding to the increase or decrease in transactions initiated by the third party affiliate 18a during the selected time period.

In addition to providing systems and methods, the present invention also provides computer program products for performing the operations described above. The computer program products have a computer readable storage medium having computer readable program code means embodied in the medium. With reference to FIG. 1, the computer readable storage medium may be part of the memory device 22, and may implement the computer readable program code means to perform the above discussed operations.

In this regard, FIGS. 2-6 are block diagram, flowchart and control flow illustrations of methods, systems and program products according to exemplary embodiments of the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer (such as a server or PC housing the transaction data tracking system 12 and component processor 20) or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for identifying trends in transactional activity of one or more transaction systems, said system comprising:
at least one transaction system capable of performing transactions; and
a tracking system in communication with said transaction system,
wherein said tracking system:
tracks the number of transactions made by the transaction system for different time periods;
determines an average number of transactions for the transaction system based on the transactions over different time periods; and
compares the average number of transactions to the number of transactions for a selected time period to identify a trend in the number of transactions for the selected time period.

2. A system according to claim 1, wherein said tracking system determines the average number of transactions for an N number of time periods and the number of transactions for an N+1 time period and compares the average number of transactions for the N number of time periods to the number of transactions for the N+1 time period.

3. A system according to claim 1, wherein the time period is one of a day, a week, a month, a quarter of a year, or a year.

4. A system according to claim 1, wherein said tracking system compares the transactions for successive time periods to the average number of transactions, wherein the comparisons define a slope.

5. A system according to claim 4, wherein said tracking system applies a scaling factor to the determined slope.

6. A system according to claim 5, wherein the time periods have a selected duration, and wherein the scaling factor has a value that is dependent on the duration of the time periods.

7. A system according to claim 4, wherein said tracking system applies a scaling factor to the determined slope, the scaling factor having a greater absolute value corresponding to longer selected time periods and a lesser absolute value corresponding to shorter selected time periods.

8. A system according to claim 1, wherein said tracking system calculates a slope F[X] representing a trend in the number of transactions made by a transaction system, said tracking system determining the number of transactions for a current time period N[0] and the number of transaction for a preceeding time period N[−1], and calculates the slope using the following formula:
F[X]=(N[0]−N[−1])/N[−1].

9. A system according to claim 8, wherein said tracking system applies a scaling factor K[0] to the determined slope F[X], wherein the time periods have a selected duration, and wherein the scaling factor has a value that is dependent on the duration of the time periods.

10. A system according to claim 1, wherein said tracking system calculates a slope F[X] representing a trend in the number of transactions made by a transaction system, wherein said slope F[X] is calculated based on a plurality of data samples (N[0], N[−1], N[−2], N[−3] . . . N[−n]) each representing the number of number of transactions for a time period N[x], wherein the calculation of the slope for eight samples (N[0], N[−1], N[−2], N[−3], N[−4], N[−5], N[−6], N[−7]) is:
$$\begin{matrix}F [ X ] = K [ 0 ] * ( N [ 0 ] + N [ - 1 ] ) / N [ - 1 ] + K [ 1 ] * \\ ( ( N [ 0 ] + N [ - 1 ] ) - ( N [ - 2 ] + N [ - 3 ] ) ) / \\ ( N [ - 2 ] + N [ - 3 ] ) + K [ 2 ] * ( ( N [ 0 ] + N [ - 1 ] + N [ - 2 ] ) - \\ ( N [ - 3 ] + N [ - 4 ] + N [ - 5 ] ) ) / ( N [ - 3 ] + N [ - 4 ] + \\ N [ - 5 ] ) + K [ 3 ] * ( ( N [ 0 ] + N [ - 1 ] + N [ - 2 ] + N [ - 3 ] ) - \\ ( N [ - 4 ] + N [ - 5 ] + N [ - 6 ] + N [ - 7 ] ) ) / \\ ( N [ - 4 ] + N [ - 5 ] + N [ - 6 ] + N [ - 7 ] ) ,\end{matrix}$$
where:
F[X] is the slope;
N is a data sample representing the number of transactions for a selected time period;
K is a scaling factor.

11. A system according to claim 10, wherein said tracking system determines an average number of transactions A[X] for the eight samples (N[0], N[−1], N[−2], N[−3], N[−4], N[−5], N[−6], N[−7]), and calculates an averaged slope FA[0] using the following formula:
FA[0]=(F[X]*A[X])/A[X].

12. A system according to claim 11, wherein said tracking system determines a filtered slope using the formula:
FR[X]=F[X]−FA[0].

13. A system according to claim 1, wherein said tracking system determines a trend value representing the number of transactions for a selected time period for a plurality of transaction systems, and identifies at least one of transaction systems having upward trends and transaction systems having downward trends.

14. A system according to claim 13, wherein said tracking system compares the trend value for each transaction system to a first threshold value, and identifies transaction systems having an associated trend value at least as great as the first threshold.

15. A system according to claim 13, wherein said tracking system compares the trend value for each transaction system to a second threshold value, and identifies transaction systems having an associated trend value less that the second threshold.

16. A system according to claim 1, wherein the transactions tracked by said tracking system are at least one of:
a number of website hits associated with the transaction system;
a purchases on the transaction system; and
inquiries concerning products offered by the transaction system.

17. A system according to claim 1, wherein the transactions tracked by said tracking system are instances when the transaction system performs a transaction on a selected system.

18. A system according to claim 1, wherein said transaction system is a computer reservation system.

19. A method for identifying trends in transactional activity of one or more transaction systems, said method comprising:
providing at least one transaction system capable of performing transactions;
tracking the number of transactions made by the transaction system for different time periods;
determining an average number of transactions for the transaction system based on the transactions over different time periods; and
comparing the average number of transactions to the number of transactions for a selected time period to identify a trend in the number of transactions for the selected time period.

20. A method according to claim 19, wherein said determining step determines the average number of transactions for an N number of time periods and the number of transactions for an N+1 time period and said comparing step compares the average number of transactions for the N number of time periods to the number of transactions for the N+1 time period.

21. A method according to claim 19, wherein the time period is one of a day, a week, a month, a quarter of a year, or a year.

22. A method according to claim 19, wherein said said comparing step compares the transactions for successive time periods to the average number of transactions, wherein the comparisons define a slope.

23. A method according to claim 22 further comprising applying a scaling factor to the determined slope.

24. A method according to claim 23, wherein the time periods have a selected duration, and wherein the scaling factor has a value that is dependent on the duration of the time periods.

25. A method according to claim 23, wherein said applying step applies a scaling factor to the determined slope, the scaling factor having a greater absolute value corresponding to longer selected time periods and a lesser absolute value corresponding to shorter selected time periods.

26. A method according to claim 19 further comprising calculating a slope F[X] representing a trend in the number of transactions made by a transaction system, said determining step determining the number of transactions for a current time period N[0] and the number of transaction for a preceeding time period N[−1], and said calculating step calculating the slope using the following formula:
F[X]=(N[0]−N[−1])/N[−1].

27. A method according to claim 26 further comprising applying a scaling factor K[0] to the determined slope F[X], wherein the time periods have a selected duration, and wherein the scaling factor has a value that is dependent on the duration of the time periods.

28. A method according to claim 19 further comprising calculating a slope F[X] representing a trend in the number of transactions made by a transaction system, wherein said slope F[X] is calculated based on a plurality of data samples (N[0], N[−1], N[−2], N[−3] . . . N[−n]) each representing the number of number of transactions for a time period N[x], wherein the calculation of the slope for eight samples (N[0], N[−1], N[−2], N[−3], N[−4], N[−5], N[−6], N[−7]) is:
$$\begin{matrix}F [ X ] = K [ 0 ] * ( N [ 0 ] + N [ - 1 ] ) / N [ - 1 ] + K [ 1 ] * \\ ( ( N [ 0 ] + N [ - 1 ] ) - ( N [ - 2 ] + N [ - 3 ] ) ) / \\ ( N [ - 2 ] + N [ - 3 ] ) + K [ 2 ] * ( ( N [ 0 ] + N [ - 1 ] + N [ - 2 ] ) - \\ ( N [ - 3 ] + N [ - 4 ] + N [ - 5 ] ) ) / ( N [ - 3 ] + N [ - 4 ] + \\ N [ - 5 ] ) + K [ 3 ] * ( ( N [ 0 ] + N [ - 1 ] + N [ - 2 ] + N [ - 3 ] ) - \\ ( N [ - 4 ] + N [ - 5 ] + N [ - 6 ] + N [ - 7 ] ) ) / \\ ( N [ - 4 ] + N [ - 5 ] + N [ - 6 ] + N [ - 7 ] ) ,\end{matrix}$$
where:
F[X] is the slope;
N is a data sample representing the number of transactions for a selected time period;
K is a scaling factor.

29. A method according to claim 28 further comprising determining an average number of transactions A[X] for the eight samples (N[0], N[−1], N[−2], N[−3], N[−4], N[−5], N[−6], N[−7]), and said calculating step calculating an averaged slope FA[0] using the following formula:
FA[0]=(F[X]*A[X])/A[X].

30. A method according to claim 29 further comprising determining a filtered slope using the formula:
FR[X]=F[X]−FA[0].

31. A method according to claim 19 further comprising determining a trend value representing the number of transactions for a selected time period for a plurality of transaction systems, and at least one of identifying transaction systems having upward trends and transaction systems having downward trends.

32. A method according to claim 31, wherein said comparing step compares the trend value for each transaction system to a first threshold value, and identifies transaction systems having an associated trend value at least as great as the first threshold.

33. A method according to claim 31, wherein said comparing step compares the trend value for each transaction system to a second threshold value, and identifies transaction systems having an associated trend value less that the second threshold.

34. A method according to claim 19, wherein the transactions tracked by said tracking step are at least one of:
a number of website hits associated with the transaction system;
a purchases on the transaction system; and
inquiries concerning products offered by the transaction system.

35. A method according to claim 19, wherein the transactions tracked by said tracking step are instances when the transaction system performs a transaction on a selected system.

36. A method according to claim 19, wherein said transaction system is a computer reservation system.

37. A computer program product for identifying trends in transactional activity of one or more transaction systems, said computer program product comprising a computer-readable storage medium having computer-readable program code portions stored therein, the computer-readable program code portions comprising:
first computer instruction means providing at least one transaction system capable of performing transactions;
second computer instruction means tracking the number of transactions made by the transaction system for different time periods;
third computer instruction means determining an average number of transactions for the transaction system based on the transactions over different time periods; and
fourth computer instruction means comparing the average number of transactions to the number of transactions for a selected time period to identify a trend in the number of transactions for the selected time period.

38. A computer program product according to claim 37, wherein said third computer instruction means determines the avearage number of transactions for an N number of time periods and the number of transactions for an N+1 time period and said fourth computer instruction means compares the average number of transaction for the N number of time periods to the number of transactions for the N+1 time period.

39. A computer program code according to claim 37, wherein the time period is one of a day, a week, a month, a quarter of a year, or a year.

40. A computer program product according to claim 37, wherein said said fourth computer instruction means compares the transactions for successive time periods to the average number of transactions, wherein the comparisons define a slope.

41. A computer program product according to claim 40 further comprising fifth computer instruction means for applying a scaling factor to the determined slope.

42. A computer program product according to claim 41, wherein the time periods have a selected duration, and wherein the scaling factor has a value that is dependent on the duration of the time periods.

43. A computer program product according to claim 41, wherein said fifth computer instruction means for applying a scaling factor to the determined slope, the scaling factor having a greater absolute value corresponding to longer selected time periods and a lesser absolute value corresponding to shorter selected time periods.

44. A computer program product according to claim 37 further comprising fifth computer instruction means calculating a slope F[X] representing a trend in the number of transactions made by a transaction system, said third computer instruction means determines the number of transactions for a current time period N[0] and the number of transaction for a preceeding time period N[−1], and said fifth computer instruction means calculating the slope using the following formula:
F[X]=(N[0]−N[−1])/N[−1].

45. A computer program product according to claim 44 further comprising sixth computer instruction means for applying a scaling factor K[0] to the determined slope F[X], wherein the time periods have a selected duration, and wherein the scaling factor has a value that is dependent on the duration of the time periods.

46. A computer program product according to claim 37 further comprising fifth computer instruction means for calculating a slope F[X] representing a trend in the number of transactions made by a transaction system, wherein said slope F[X] is calculated based on a plurality of data samples (N[0], N[−1], N[−2], N[−3] . . . N[−n]) each representing the number of number of transactions for a time period N[x], wherein the calculation of the slope for eight samples (N[0], N[−1], N[−2], N[−3], N[−4], N[−5], N[−6], N[−7]) is:
$$\begin{matrix}F [ X ] = K [ 0 ] * ( N [ 0 ] + N [ - 1 ] ) / N [ - 1 ] + K [ 1 ] * \\ ( ( N [ 0 ] + N [ - 1 ] ) - ( N [ - 2 ] + N [ - 3 ] ) ) / \\ ( N [ - 2 ] + N [ - 3 ] ) + K [ 2 ] * ( ( N [ 0 ] + N [ - 1 ] + N [ - 2 ] ) - \\ ( N [ - 3 ] + N [ - 4 ] + N [ - 5 ] ) ) / ( N [ - 3 ] + N [ - 4 ] + \\ N [ - 5 ] ) + K [ 3 ] * ( ( N [ 0 ] + N [ - 1 ] + N [ - 2 ] + N [ - 3 ] ) - \\ ( N [ - 4 ] + N [ - 5 ] + N [ - 6 ] + N [ - 7 ] ) ) / \\ ( N [ - 4 ] + N [ - 5 ] + N [ - 6 ] + N [ - 7 ] ) ,\end{matrix}$$
where:
F[X] is the slope;
N is a data sample representing the number of transactions for a selected time period;
K is a scaling factor.

47. A computer program product according to claim 46 further comprising sixth computer instruction means for determining an average number of transactions A[X] for the eight samples (N[0], N[−1], N[−2], N[−3], N[−4], N[−5], N[−6], N[−7]), and said calculating step calculating an averaged slope FA[0] using the following formula:
FA[0]=(F[X]*A[X])/A[X].

48. A computer program product according to claim 47 further comprising seventh computer instruction means for determining a filtered slope using the formula:
FR[X]=F[X]−FA[0].

49. A computer program product according to claim 37 further comprising fifth computer instruction means for determining a trend value representing the number of transactions for a selected time period for a plurality of transaction systems, and at least one of identifying transaction systems having upward trends and transaction systems having downward trends.

50. A computer program product according to claim 49, wherein said fourth computer instruction means compares the trend value for each transaction system to a first threshold value, and identifies transaction systems having an associated trend value at least as great as the first threshold.

51. A computer program product according to claim 50, wherein said fourth computer instruction means compares the trend value for each transaction system to a second threshold value, and identifies transaction systems having an associated trend value less that the second threshold.

52. A computer program product according to claim 37, wherein the transactions tracked by said second computer instruction means are at least one of:
a number of website hits associated with the transaction system;
a purchases on the transaction system; and
inquiries concerning products offered by the transaction system.

53. A computer program product according to claim 37, wherein the transactions tracked by said second computer instruction means are instances when the transaction system performs a transaction on a selected system.

54. A computer program product according to claim 37, wherein said transaction system is a computer reservation system.
